(19) United States
(12) Patent Application Publication
(10) Pub. No.: US 2011/0063245 A1
(43) Pub. Date: Mar. 17, 2011

(54) TOUCH APPARATUS AND DISPLAY PANEL THEREOF

(75) Inventor: Shao-Yang Chiang, Hsinchu City (TW)

(73) Assignee: NOVATEK MICROELECTRONICS CORP., Hsinchu (TW)

(21) Appl. No.: 12/758,757

(22) Filed: Apr. 12, 2010

(30) Foreign Application Priority Data
Sep. 17, 2009 (TW) 98131390

(51) Int. Cl. G06F 3/045

(52) U.S. Cl. 345/174; 178/18.05

(57) ABSTRACT

A touch apparatus and a display panel thereof are provided. The touch apparatus includes an upper substrate and a lower substrate. The lower substrate at least includes a first selection line, a first readout line intersected with the first selection line, a first conductive bump, and a second conductive bump. The first and the second conductive bumps are disposed at the intersection of the first selection line and the first readout line, and electrically connected with the first selection line and the first readout line, respectively. The upper substrate at least includes a first conductive layer without potential, which is disposed above the first and the second conductive bumps. When an external force is exerted to the first conductive layer without potential, the first and the second conductive bumps are electrically connected to each other by the first conductive layer without potential.

### CROSS-REFERENCE TO RELATED APPLICATION

This application claims the priority benefit of Taiwan application serial no. 98131390, filed on Sep. 17, 2009. The entirety of the above-mentioned patent application is hereby incorporated by reference herein and made a part of specification.

### BACKGROUND OF THE INVENTION

1. Field of the Invention

The present invention relates to a touch panel, more particularly, to a touch apparatus integrated to a display panel.

2. Description of Related Art

With quick development of technology, touch panels are equipped to a plurality of electronic devices (such as personal digital assistants (PDAs), mobile phones, etc.) for operation convenience. Conventionally, the electronic device having the touch panel can be formed by attaching an independent touch panel and an independent display module. However, considering a fabrication cost, an idea of integrating the touch panel with a display panel of the display module is provided, so as to reduce the fabrication cost of the electronic device having the touch panel.

FIG. 1 is a partial schematic diagram illustrating a conventional display panel integrated with a touch panel. Referring to FIG. 1, to integrate the touch panel with the display panel 101, a metal oxide semiconductor (MOS) transistor T is specially configured on a lower substrate 101a (which is generally a pixel array substrate) of the display panel 101 to electrically connected to a selection line SL, a readout line RL and a conductive bump CB disposed on the lower substrate 101a, respectively. Wherein, a gate of the MOS transistor T is electrically connected to the selection line SL, a source of the MOS transistor T is electrically connected to the readout line RL, and a drain of the MOS transistor T is electrically connected to the conductive bump CB.

When the selection line SL receives a selection signal SS, and an upper substrate 101b (which is generally a color filter substrate) of the display panel 101 that is located above the conductive bump CB is pressed by a finger or other medium, since the MOS transistor T is now conducted, a common voltage Vcom received by a conductive layer (which is generally a indium-tin oxide layer) of the upper substrate 101b is transmitted to the readout line RL through the conductive bump CB and the MOS transistor T. Therefore, by determining whether the readout line RL obtains the common voltage Vcom, it can be determined whether the upper substrate 101b of the display panel 101 that is located above the conductive bump CB is pressed.

### SUMMARY OF THE INVENTION

The present invention provides a touch apparatus integrated to a display panel. The touch apparatus includes an upper substrate and a lower substrate. The lower substrate at least includes a first selection line, a first readout line intersected with the first selection line, a first conductive bump, and a second conductive bump. The first conductive bump is disposed at an intersection of the first selection line and the first readout line, and is electrically connected to the first selection line. The second conductive bump is disposed at the intersection of the first selection line and the first readout line, and is electrically connected to the first readout line. The upper substrate at least includes a first conductive layer without potential, which is disposed above the first and the second conductive bumps. When an external force is exerted to the first conductive layer without potential, the first and the second conductive bumps are electrically connected to each other by the first conductive layer without potential.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial schematic diagram illustrating a conventional display panel integrated with a touch panel.

FIG. 2 is a schematic diagram illustrating a touch apparatus according to an embodiment of the present invention.

FIG. 3 is a schematic diagram illustrating an upper substrate according to an embodiment of the present invention.

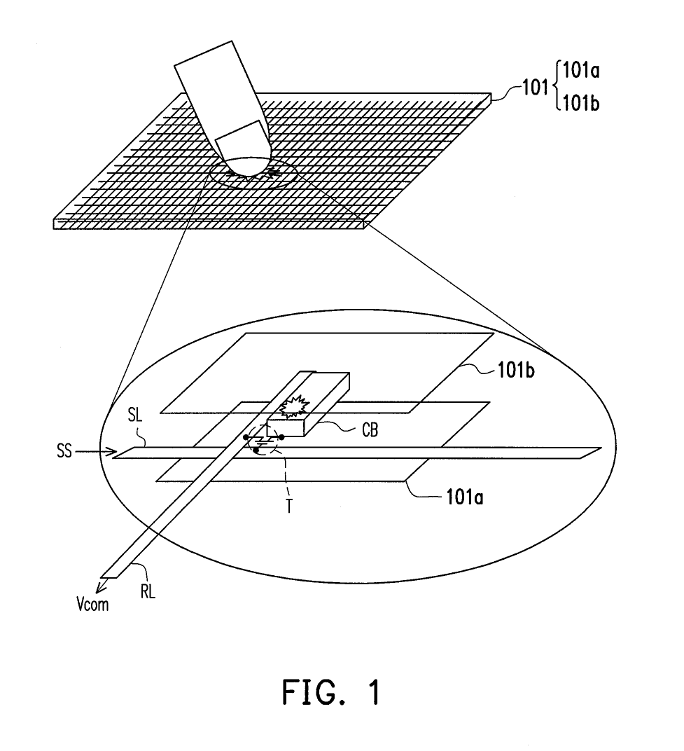

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

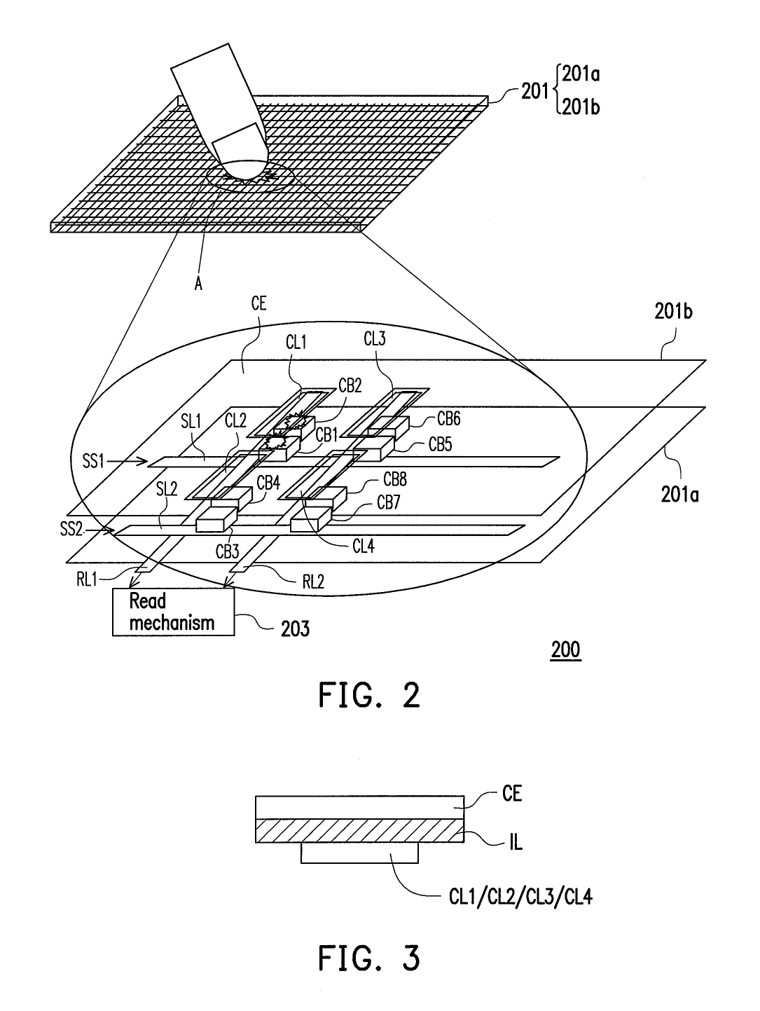

FIG. 2 is a schematic diagram illustrating a touch apparatus 200 according to an embodiment of the present invention. Referring to FIG. 2, the touch apparatus 200 includes a touch panel 201 and a read mechanism 203. Wherein, the touch panel 201 is integrated with a display panel, and includes an upper substrate 201b (for example, a color filter substrate) and a lower substrate 201a (for example, a pixel array substrate). For simplicity's sake, only two selection lines SL1 and SL2 used for sequentially receiving selection signals SS1 and SS2, two readout lines RL1 and RL2, and eight conductive bumps CB1-CB8 are illustrated on an amplified diagram of a region A of the lower substrate 201a, and one conductive layer with potential CE (for example, an indium-tin oxide layer, which is used for receiving a common voltage) and four conductive layers without potential CL1-CL4 are illustrated on an amplified diagram of the region A of the upper substrate 201b, wherein the conductive layer with potential CE respectively surrounds the conductive layers without potential CL1-CL4 in the same plane, and is not electrically connected to the conductive layers without potential CL1-CL4.

In the present embodiment, the readout line RL1 is individually intersected with the selection lines SL1 and SL2, and the readout line RL2 is also individually intersected with the selection lines SL1 and SL2. The conductive bump CB1 is disposed at an intersection of the selection line SL1 and the readout line RL1, and is electrically connected to the selection line SL1. The conductive bump CB2 is also disposed at the intersection of the selection line SL1 and the readout line RL1, and is electrically connected to the readout line RL1. Similarly, the conductive bump CB3 is disposed at an intersection of the selection line SL2 and the readout line RL1, and is electrically connected to the selection line SL2. The conductive bump CB4 is also disposed at the intersection of the selection line SL2 and the readout line RL1, and is electrically connected to the readout line RL1.

The conductive bump CB5 is disposed at an intersection of the selection line SL1 and the readout line RL2, and is electrically connected to the selection line SL1.

The conductive bump CB6 is also disposed at the intersection of the selection line SL1 and the readout line RL2, and is electrically connected to the readout line RL2. The conductive bump CB7 is disposed at an intersection of the selection line SL2 and the readout line RL2, and is electrically connected to the selection line SL2. The conductive bump CB8 is also disposed at the intersection of the selection line SL2 and the readout line RL2, and is electrically connected to the readout line RL2.

The conductive layer without potential CL1 is disposed above the conductive bumps CB1 and CB2, and when an external force (for example, by a finger or other medium) is exerted to the conductive layer without potential CL1, the conductive bumps CB1 and CB2 are electrically connected to each other by the conductive layer without potential CL1. Similarly, the conductive layer without potential CL2 is disposed above the conductive bumps CB3 and CB4, and when the external force is exerted to the conductive layer without potential CL2, the conductive bumps CB3 and CB4 are electrically connected to each other by the conductive layer without potential CL2.

The conductive layer without potential CL3 is disposed above the conductive bumps CB5 and CB6, and when the external force is exerted to the conductive layer without potential CL3, the conductive bumps CB5 and CB6 are electrically connected to each other by the conductive layer without potential CL3. The conductive layer without potential CL4 is disposed above the conductive bumps CB7 and CB8, and when the external force is exerted to the conductive layer without potential CL4, the conductive bumps CB7 and CB8 are electrically connected to each other by the conductive layer without potential CL4.

According to the above description, when the selection line SL1 receives the selection signal SS1, and meanwhile a user presses the conductive layer without potential CL1 through a finger or other medium, since the conductive bumps CB1 and CB2 are electrically connected to each other by the conductive layer without potential CL1, the selection signal SS1 is transmitted to the readout line RL1, so that the readout line RL1 obtains the selection signal SS1. Now, if the user does not press the conductive layer without potential CL3 through the finger or other medium, the readout line RL2 does not obtain the selection signal SS1. Therefore, the read mechanism 203 determines that the user now presses the conductive layer without potential CL1 through the finger or other medium according to a fact that the readout line RL1 obtains the selection signal SS1.

On the other hand, when the selection line SL1 receives the selection signal SS1, and meanwhile the user simultaneously presses the conductive layers without potential CL1 and CL3 through the finger or other medium, since the readout lines RL1 and RL2 simultaneously obtain the selection signal SS1, the read mechanism 203 determines that the user now simultaneously presses the conductive layers without potential CL1 and CL3 through the finger or other medium according to a fact that the readout lines RL1 and RL2 simultaneously obtain the selection signal SS1. Similarly, the read mechanism 203 can also determine whether the user presses the conductive layer without potential CL3 and/or the conductive layer without potential CL4 through the finger or other medium according to whether the readout line RL1 and/or the readout line RL2 obtain/obtains the selection signal SS2, and detailed descriptions thereof are not repeated.

In the present embodiment, it is assumed that the conductive layer with potential CE respectively surrounds the conductive layers without potential CL1-CL4 in the same plane, and is not electrically connected to the conductive layers without potential CL1-CL4, though in another embodiment of the present invention, as shown in FIG. 3, an insulation layer IL can be disposed between the conductive layer with potential CE and the conductive layers without potential CL1-CL4 (i.e. the conductive layer with potential CE and the conductive layers without potential CL1-CL4 are not in the same plane), by which the same technical function of the above embodiment can also be achieved, and detailed descriptions thereof are not repeated.

Accordingly, two conductive bumps are disposed at the intersection of the selection line and the readout line to electrically connect with the selection line and the readout line, respectively, and a conductive layer without potential is disposed above the two conductive bumps. By such means, once the selection line receives the selection signal, by determining whether the readout line obtains the selection signal, it can be determined whether the conductive layer without potential that is disposed above the two conductive bumps is pressed. Therefore, compared to the conventional technique, the structure of the touch panel of the present invention is quite simple, and a method for detecting a touch operation is also simple. Moreover, since a technique of detecting the touch operation of the present invention is to determine whether the conductive layer without potential is electrically connected to the conductive bumps, almost no power is consumed during the process of detecting the touch operation, so that a power consumption of the applied electronic/touch apparatus can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch apparatus, comprising:
a lower substrate, at least comprising:
a first selection line;
a first readout line, intersected with the first selection line;
a first conductive bump, disposed at an intersection of the first selection line and the first readout line, and electrically connected to the first selection line;
a second conductive bump, disposed at the intersection of the first selection line and the first readout line, and electrically connected to the first readout line; and
an upper substrate, at least comprising a first conductive layer without potential that is disposed above the first and the second conductive bumps,
wherein when an external force is exerted to the first conductive layer without potential, the first and the second conductive bumps are electrically connected to each other by the first conductive layer without potential.

2. The touch apparatus as claimed in claim 1, wherein the lower substrate further comprises:
a second selection line, intersected with the first readout line;
a third conductive bump, disposed at an intersection of the second selection line and the first readout line, and electrically connected to the second selection line; and
a fourth conductive bump, disposed at the intersection of the second selection line and the first readout line, and electrically connected to the first readout line.

3. The touch apparatus as claimed in claim 2, wherein the upper substrate further comprises a second conductive layer without potential that is disposed above the third and the fourth conductive bumps,
wherein when an external force is exerted to the second conductive layer without potential, the third and the fourth conductive bumps are electrically connected to each other by the second conductive layer without potential.

4. The touch apparatus as claimed in claim 3, wherein the lower substrate further comprises:
a second readout line, respectively intersected with the first and the second selection lines;
a fifth conductive bump, disposed at an intersection of the first selection line and the second readout line, and electrically connected to the first selection line;
a sixth conductive bump, disposed at the intersection of the first selection line and the second readout line, and electrically connected to the second readout line;
a seventh conductive bump, disposed at an intersection of the second selection line and the second readout line, and electrically connected to the second selection line; and
an eighth conductive bump, disposed at the intersection of the second selection line and the second readout line, and electrically connected to the second readout line.

5. The touch apparatus as claimed in claim 4, wherein the upper substrate further comprises:
a third conductive layer without potential that is disposed above the fifth and the sixth conductive bumps; and
a fourth conductive layer without potential that is disposed above the seventh and the eighth conductive bumps,
wherein when the external force is exerted to the third conductive layer without potential, the fifth and the sixth conductive bumps are electrically connected to each other by the third conductive layer without potential; and
when the external force is exerted to the fourth conductive layer without potential, the seventh and the eighth conductive bumps are electrically connected to each other by the fourth conductive layer without potential.

6. The touch apparatus as claimed in claim 5, wherein the upper substrate further comprises a conductive layer with potential.

7. The touch apparatus as claimed in claim 6, wherein the conductive layer with potential respectively surrounds the first, the second, the third, and the fourth conductive layers without potential, and is not electrically connected to the first, the second, the third and the fourth conductive layers without potential.

8. The touch apparatus as claimed in claim 6, wherein the upper substrate further comprises an insulation layer disposed between the conductive layer with potential and the first, the second, the third, and the fourth conductive layers without potential.

9. The touch apparatus as claimed in claim 5, wherein the first and the second selection lines sequentially receive a first and a second selection signals.

10. The touch apparatus as claimed in claim 9, wherein when the first selection line receives the first selection signal, and the external force is exerted to the first conductive layer without potential, the first readout line obtains the first selection signal.

11. The touch apparatus as claimed in claim 10, wherein when the first selection line receives the first selection signal, and the external force is exerted to the third conductive layer without potential, the second readout line obtains the first selection signal.

12. The touch apparatus as claimed in claim 11, wherein when the second selection line receives the second selection signal, and the external force is exerted to the second conductive layer without potential, the first readout line obtains the second selection signal.

13. The touch apparatus as claimed in claim 12, wherein when the second selection line receives the second selection signal, and the external force is exerted to the fourth conductive layer without potential, the second readout line obtains the second selection signal.

14. The touch apparatus as claimed in claim 13, further comprising:
a read mechanism, coupled to the first readout line and the second readout line, for determining whether the first and the second readout lines simultaneously or individually obtain the first or the second selection signal, so as to determine whether the external force is exerted to the first and/or the third conductive layer without potential, or exerted to the second and/or the fourth conductive layer without potential.

15. The touch apparatus as claimed in claim 1, wherein the lower substrate is a pixel array substrate, and the upper substrate is a color filter substrate.

16. A display panel, comprising:
a pixel array substrate, comprising:
a first selection line;
a first readout line, intersected with the first selection line;
a first conductive bump, disposed at an intersection of the first selection line and the first readout line, and electrically connected to the first selection line;
a second conductive bump, disposed at the intersection of the first selection line and the first readout line, and electrically connected to the first readout line; and
a color filter substrate, disposed above the pixel array substrate, and comprising:
a first conductive layer without potential, disposed above the first and the second conductive bumps,
wherein when an external force is exerted to the first conductive layer without potential, the first and the second conductive bumps are electrically connected to each other by the first conductive layer without potential.

17. The display panel as claimed in claim 16, wherein the pixel array substrate further comprises:
a second selection line, intersected with the first readout line;
a third conductive bump, disposed at an intersection of the second selection line and the first readout line, and electrically connected to the second selection line; and
a fourth conductive bump, disposed at the intersection of the second selection line and the first readout line, and electrically connected to the first readout line.

18. The display panel as claimed in claim 17, wherein the color filter substrate further comprises a second conductive layer without potential that is disposed above the third and the fourth conductive bumps,
wherein when an external force is exerted to the second conductive layer without potential, the third and the fourth conductive bumps are electrically connected to each other by the second conductive layer without potential.

19. The display panel as claimed in claim 18, wherein the pixel array substrate further comprises:
a second readout line, respectively intersected with the first and the second selection lines;
a fifth conductive bump, disposed at an intersection of the first selection line and the second readout line, and electrically connected to the first selection line;
a sixth conductive bump, disposed at the intersection of the first selection line and the second readout line, and electrically connected to the second readout line;
a seventh conductive bump, disposed at an intersection of the second selection line and the second readout line, and electrically connected to the second selection line; and
an eighth conductive bump, disposed at the intersection of the second selection line and the second readout line, and electrically connected to the second readout line.

20. The display panel as claimed in claim 19, wherein the color filter substrate further comprises:
a third conductive layer without potential that is disposed above the fifth and the sixth conductive bumps; and
a fourth conductive layer without potential that is disposed above the seventh
and the eighth conductive bumps,
wherein when the external force is exerted to the third conductive layer without potential, the fifth and the sixth conductive bumps are electrically connected to each other by the third conductive layer without potential; and
when the external force is exerted to the fourth conductive layer without potential, the seventh and the eighth conductive bumps are electrically connected to each other by the fourth conductive layer without potential.

21. The display panel as claimed in claim 20, wherein the color filter substrate further comprises a conductive layer with potential.

22. The display panel as claimed in claim 21, wherein the conductive layer with potential respectively surrounds the first, the second, the third, and the fourth conductive layers without potential, and is not electrically connected to the first, the second, the third and the fourth conductive layers without potential.

23. The display panel as claimed in claim 21, wherein the color substrate further comprises an insulation layer disposed between the conductive layer with potential and the first, the second, the third, and the fourth conductive layers without potential.
